(19) United States
(12) Patent Application Publication
(10) Pub. No.: US 2025/0259353 A1
(43) Pub. Date: Aug. 14, 2025

(54) METHOD AND SYSTEM FOR GENERATING PEDESTRIAN THERMODYNAMIC DIAGRAM

(71) Applicant: BOE TECHNOLOGY GROUP CO., LTD., Beijing (CN)

(72) Inventor: Weiyang Hu, Beijing (CN)

(73) Assignee: BOE TECHNOLOGY GROUP CO., LTD., Beijing (CN)

(21) Appl. No.: 18/702,416

(22) PCT Filed: May 4, 2023
(86) PCT No.: PCT/CN2023/092014

§ 371 Date: Apr. 18, 2024

(30) Foreign Application Priority Data
Jun. 24, 2022 (CN) 202210727009.7

(51) Int. Cl. G06T 11/20; G06T 7/20; G06T 7/70; G06T 11/00

(52) U.S. Cl. CPC G06T 11/206; G06T 7/20; G06T 7/70; G06T 11/001; G06T 2207/20021; G06T 2207/30196; G06T 2207/30242

(57) ABSTRACT

A method and system for generating a pedestrian thermodynamic diagram are provided. The method includes: obtaining coordinates of at least one pedestrian in a scene; counting, based on the coordinates of at least one pedestrian, at least one pedestrian separately within a corresponding grid of multiple grids obtained by dividing the scene; and counting the number of the at least one pedestrian within each grid of multiple grids to draw a pedestrian thermodynamic diagram in the scene.

### TECHNICAL FIELD

The present application relates to the field of computer technologies, in particular to a method and system for generating a pedestrian thermodynamic diagram.

### BACKGROUND

Computer vision refers to the use of cameras and computers instead of the human eye to recognize, track, and measure a target, and further perform graphic processing to make a computer-processed image more suitable for human observation or transmission to instruments for detection.

In scenarios such as smart retail and smart finance, computer vision can be used to display the distribution of crowd density.

### SUMMARY

According to an aspect of the application, a method for generating pedestrian thermodynamic diagram is provided, and the method includes: obtaining image data containing pedestrians and determining coordinates of at least one pedestrian in a scene; based on the coordinates of at least one pedestrian, counting at least one pedestrian separately within a corresponding grid of multiple grids obtained by dividing the scene; and counting the number of the pedestrians in each grid of multiple grids to draw a pedestrian thermodynamic diagram in the scene.

In some embodiments, based on the coordinates of at least one pedestrian, the counting at least one pedestrian separately within the corresponding grid of multiple grids obtained by dividing the scene includes: based on a predetermined fine granularity, dividing the scene into multiple grids; and based on the coordinates of at least one pedestrian and multiple grids, counting at least one pedestrian separately within the corresponding grid.

In some embodiments, based on the coordinates of at least one pedestrian and multiple grids, the counting at least one pedestrian separately within the corresponding grid includes: assigning an index value to each grid of multiple grids in a coordinate system of the scene; taking, by using length and width values of each grid of the multiple grids, quotient values of the coordinates in length and width directions of each of at least one pedestrian separately along length and width directions of the multiple grids, to obtain a first coordinate quotient value and a second coordinate quotient value corresponding to the coordinates of each pedestrian; and comparing the first coordinate quotient value and the second coordinate quotient value with the index value of each grid to count each pedestrian within the corresponding grid.

In some embodiments, the obtaining image data containing pedestrians and determine coordinates of at least one pedestrian in the scene includes: acquiring the image data of the pedestrian in the scene separately at multiple image data acquisition moments every first predetermined time; and the counting the number of the pedestrians in each grid of multiple grids includes: counting the pedestrian in each grid based on the image data acquired at each image data acquisition moment, to count the pedestrians in each grid for each image data acquisition moment.

In some embodiments, the counting the number of the pedestrians in each grid of multiple grids further includes: marking and tracking the pedestrian in the scene; and judging whether the coordinates of the tracked pedestrian obtained at two adjacent image data acquisition moments of the image data are located in the same grid; if the coordinates are within the same grid, not counting the pedestrian at later image data acquisition moment; if the coordinates are located in different grids, counting the pedestrians at later image data acquisition moment.

In some embodiments, the counting the number of the pedestrians in each grid of multiple grids to draw the pedestrian thermodynamic diagram in the scene includes: counting the pedestrian in each grid separately for multiple image data acquisition moments; marking each grid differently based on difference in a sum of the number of the pedestrians in each grid at each image data acquisition moment; and determining different marks for each grid at multiple image data acquisition moments to obtain the time-varying pedestrian thermodynamic diagram in the scene.

In some embodiments, the marking each grid differently includes: drawing different display colors for the grids depending on the difference in the sum of the number of the pedestrians in each grid.

In some embodiments, the obtaining image data containing pedestrians and determine coordinates of at least one pedestrian in the scene further includes: extracting first coordinates of the pedestrian from the image data based on a coordinate system of an image acquisition device of the image data; and transforming the first coordinates to a second coordinates based on the coordinate system of the scene, and using the second coordinates as coordinates of the pedestrian in the scene.

In some embodiments, the extracting first coordinates of the pedestrian from the image data based on the coordinate system of the image acquisition device of the image data includes: obtaining original coordinates of the pedestrian based on the coordinate system of the image acquisition device of the image data; obtaining a correction value of the original coordinates through the following formula:

$$x = \frac{( \vert {x}_{2} - {x}_{1} \vert ) h}{H}$$

where, H represents a height of the image acquisition device of the image data, x2 represents center coordinates of the scene where the image acquisition device of the image data is located, x1 represents original coordinates obtained by the image acquisition device, h represents the height of the pedestrian, and x represents a correction value of the original coordinates; and correcting the original coordinates by using the correction value of the original coordinates based on a quadrant of the coordinate system of the image acquisition device where the original coordinates are located, to obtain the first coordinates.

In some embodiments, the height of the pedestrian is a mode of heights of pedestrians.

In some embodiments, the original coordinates, the first coordinates, and the second coordinates include head coordinates of the at least one pedestrian.

In some embodiments, the acquiring the image data of the pedestrians in the scene separately at multiple image data acquisition moments every first predetermined time includes: setting the image acquisition device at a position higher than the height of the at least one pedestrian to acquire the head image data of the at least one pedestrian.

In some embodiments, the setting the image acquisition device at the position higher than the height of the pedestrians to acquire the head image data of the pedestrian includes: acquiring the head image data of the at least one pedestrian through an image acquisition device located at a center of the scene.

In some embodiments, the setting the image acquisition device at the position higher than the height of the pedestrian to acquire the head image data of the pedestrian includes: acquiring the head image data of the pedestrian through multiple image acquisition devices having an acquisition area covering the entire scene.

In some embodiments, in the scene, there is also an acquisition overlapping area of at least two image acquisition devices, and the acquiring the head image data of the pedestrian through multiple image acquisition devices having an acquisition area covering the entire scene includes: selecting head image data of at least one pedestrian acquired by one of at least two image acquisition devices corresponding to the acquisition overlapping area.

In some embodiments, in the scene, there is also a noise area, and the acquiring the head image data of the pedestrian through multiple image acquisition devices having an acquisition area covering the entire scene includes: not acquiring the head image data of the pedestrian in the noise area.

In some embodiments, the transforming the first coordinates to the second coordinates based on the coordinate system of the scene includes: by rotating coordinates, transforming the first coordinates based on the coordinate system of the image acquisition device of the image data to the second coordinates of the coordinate system of the scene.

According to another aspect of the application, providing a system for generating pedestrian thermodynamic diagram, including: at least one image acquisition device; a processor; and a memory, the at least one image acquisition device is configured to acquire image data of at least one pedestrian in a scene and send the image data to the processor and/or the memory, and the memory stores an instruction that can be executed by the processor, the instruction, when executed by the processor, causes the processor to perform the foregoing method.

In some embodiments, the at least one image acquisition device includes one image acquisition device, a height of the image acquisition device is greater than a height of the at least one pedestrian, and the image acquisition device is located at a center of the scene.

In some embodiments, the at least one image acquisition device includes at least two image acquisition devices, heights of at least two image acquisition devices are greater than a height of the at least one pedestrian, and the at least two image acquisition devices have an image acquisition area covering an entire scene.

### BRIEF DESCRIPTION OF THE DRAWINGS

The drawings are intended to provide a further understanding of the present application, constitute a part of the specification and explain the present application in conjunction with the specific embodiments below, rather than constitute a limitation to the present application. In the drawings:

FIG. 1 is a flow chart of a method for generating a pedestrian thermodynamic diagram according to an embodiment of the present application;

FIG. 2 is a schematic diagram of coordinate correction according to an embodiment of the present application;

FIG. 3 is a schematic diagram of coordinate fusion according to embodiments of the present application;

FIG. 4 is a pedestrian thermodynamic diagram according to embodiments of the present application;

FIG. 5 is a schematic diagram of a system for generating a pedestrian thermodynamic diagram according to embodiments of the present application; and

FIG. 6 is another schematic diagram of a system for generating a pedestrian thermodynamic diagram according to embodiments of the present application.

### DETAILED DESCRIPTION

The embodiments of the present application will be described in detail with reference to the accompanying drawings. It should be understood that the specific embodiments described herein are only for illustration and explanation of the present application, and are not used for limiting the present application.

In order to make the objectives, technical solutions and advantages of the present application clearer, the technical solutions in the embodiments of the present application will be described clearly and completely below with reference to the drawings in the embodiments of the present application. Obviously, the described embodiments are only a part of the embodiments of the present application, rather than all of them. Based on the described embodiments of the present application, all other embodiments obtained by those of ordinary skill in the art without creative work shall fall within the protection scope of the present application.

Unless otherwise defined, technical terms or scientific terms used in the present application shall have the common meanings understood by those with ordinary skills in the art to which the present application belongs. “First”, “second” and similar words used in the present application do not indicate any order, quantity, or importance, but are only used to distinguish different components. “Include” or “comprise” and other similar words mean that the element or item before the word encompasses the element or item and their equivalents listed after the word, but does not exclude other elements or items. Similar words such as “coupled” or “connected” are not limited to physical or mechanical connections, but may include electrical connections, whether direct or indirect.

According to an aspect of the application, a method for generating pedestrian thermodynamic diagram is provided, enabling observers to intuitively perceive the density of pedestrians in an area. FIG. 1 is a flow chart of a method for generating a pedestrian thermodynamic diagram according to the embodiments of the present application. The following is a detailed explanation of the present application with reference to FIG. 1.

In step S100, obtain image data containing pedestrians and determine coordinates of at least one pedestrian in a scene.

Specifically, the image data of the pedestrians in the scene is acquired firstly. An image acquisition device, such as a camera, can be used to obtain video streams. The video streams are saved as image data for processing. When obtaining the image data of the pedestrians in the scene, the image data of the pedestrians in the scene at corresponding moment can be acquired every first predetermined time. Furthermore, the image data of the pedestrians in the scene is acquired separately at multiple image data acquisition moments every first predetermined time.

Then, original coordinates of the pedestrian is obtained from the image data based on a coordinate system of an image acquisition device of the image data. The coordinate system of the image data of the pedestrian acquired by the image acquisition device is based on the corresponding image acquisition device. The original coordinates of the pedestrians in this coordinate system is obtained for subsequent processing.

In addition, coordinate errors are caused by perspective effect of the image acquisition device, resulting in errors in the obtained original coordinates. Therefore, it is necessary to correct the original coordinates.

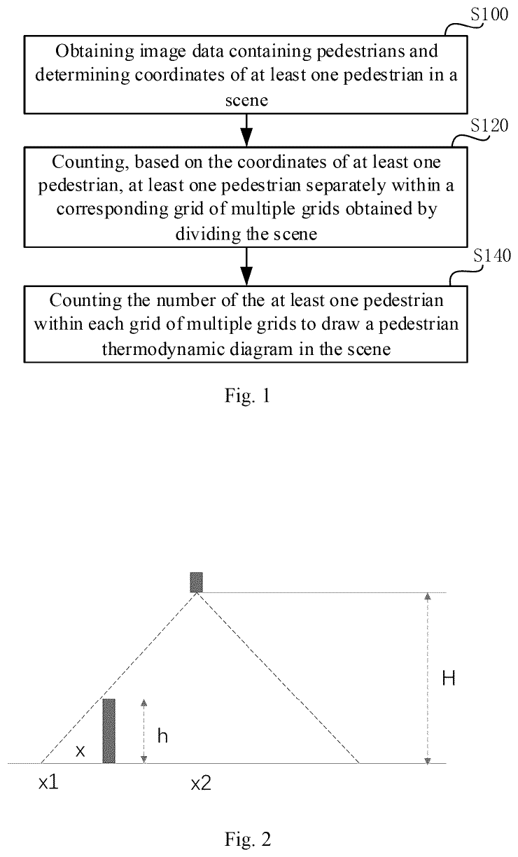

FIG. 2 is a schematic diagram of coordinate correction according to the embodiments of the present application. As shown in FIG. 2, taking obtaining head coordinates of the pedestrian through a single camera as an example, by using mathematical formulas, the measured original coordinates are corrected to obtain corrected first coordinates of the pedestrian based on the coordinate system of the image acquisition device.

As shown in FIG. 2, H represents an installation a height of the camera, x2 is center coordinates of the scene where the camera is located, x1 is the original head coordinates of the pedestrian in the coordinate system of the image acquisition device, h is the height of the pedestrian (taking the mode of heights, for example, 1.6 m), and x is a correction value of the original coordinates. The correction value of the original coordinates is obtained through the following formula.

$$x = \frac{( \vert {x}_{2} - {x}_{1} \vert ) h}{H} \qquad ( 1 )$$

The corrected coordinates (the first coordinates) are x1-x or x1+x, depending on the quadrant where the coordinate point is located. Therefore, based on the corrected value and the original coordinates, the first coordinates corrected for the original coordinates are obtained. For example, for the example shown in FIG. 2, if x1 is located on the positive side of x2 extending along the coordinate axis X, then the first coordinates corrected for the original coordinates are x1−x; if x1 is located on the negative side of x2 extending along the coordinate axis X, the first coordinates corrected for the original coordinates are x1+x. But this application is not limited to this.

Next, the first coordinates of the pedestrian is transformed to a second coordinates based on a coordinate system of the scene. The first coordinates of the pedestrian are based on the coordinate system of the image acquisition device, while the second coordinates are based on the coordinate system of the scene, such as the ground (i.e. the scene plane). The coordinate system of the image acquisition device is achieved by setting configuration parameters, and the coordinate system of the scene may be manually set based on the actual environment, so the two coordinate systems may be different. So, it may be necessary to transform the first coordinates of the pedestrian in the coordinate system of the image acquisition device to the second coordinates based on the coordinate system of the scene, and the second coordinates is used as the coordinates of the pedestrians in the scene.

In this application, the first coordinates obtained by the image acquisition device is illustrated using the head coordinates of the pedestrian as an example.

FIG. 2 illustrates an example of acquiring the head image data of the pedestrian through an image acquisition device located at the center of the scene, but the application is not limited to this. When the scene range is large, multiple (such as at least two) image acquisition devices can be used to acquire the head image data of the pedestrian, as long as the entire acquisition area of multiple image acquisition devices covers the entire scene.

Furthermore, for acquiring the head image data of the pedestrian through multiple image acquisition devices, since the head image data acquired by each image acquisition device is based on their respective coordinate systems, and the coordinate system of each image acquisition device may not be aligned, it is necessary to fuse the independent coordinates of the coordinate system of each image acquisition device to the coordinate system of the scene based on the installation position and angle of each camera.

Assuming that three USB cameras are used to achieve full coverage of the scene. Each camera has an independent detection program. For practical needs, the coordinate fusion is performed in the present application based on scene plane. For the first coordinates output by each camera, it is necessary to fuse the first coordinates into scene coordinates based on the installation position and angle of the camera.

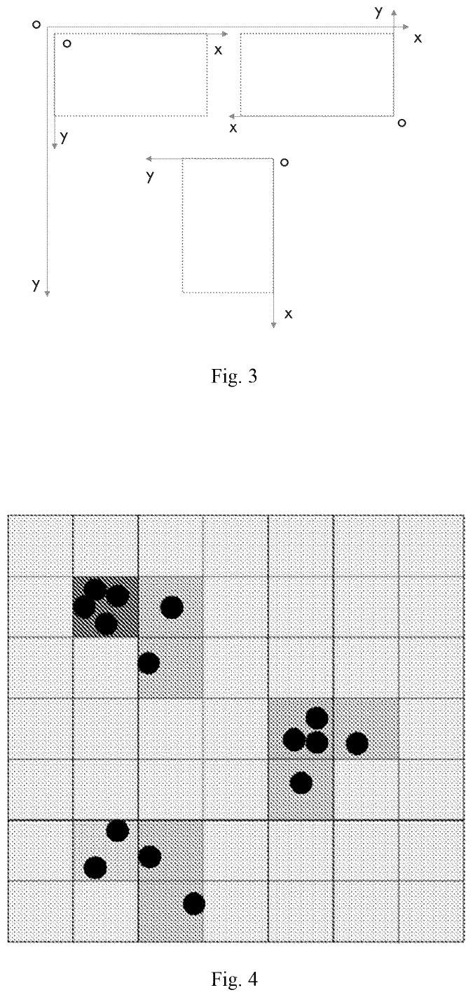

FIG. 3 is a schematic diagram of coordinate fusion according to the embodiments of the present application. As shown in FIG. 3, four coordinate systems are shown. For example, the outermost coordinate system with origin o in the upper left corner is the coordinate system of the scene, and the remaining three coordinate systems represent the coordinate systems of three USB cameras. The following is an explanation of the coordinate fusion process with reference to FIG. 3.

Firstly, the center coordinates (Xi, Yi) of each camera in the coordinate system of the scene are determined through field measurements, which are the coordinates of the origin o of the three USB cameras in FIG. 3 in the coordinate system of the scene. After obtaining the detection data from each camera, the head coordinates of the pedestrian obtained through the corresponding camera will be rotated and transformed (if necessary) to obtain rotation coordinates. The transformation process utilizes trigonometric functions, as shown in formula (2), where (x, y) is the original coordinates and (s, t) is transformed coordinates, β is the rotation angle, α is angle between a vector from the origin to (x, y) and the coordinate axis X, γ is a modulus of the vector from the origin to (x, y), counterclockwise is positive.

$$s = r cos ( α + β ) = r cos αcosβ + r sin α sin β = x cos β - y sin β \\ t = r sin ( α + β ) = r sin αcosβ + r cos α sin β = y cos β + x sin β \qquad ( 2 )$$

Then the coordinate system of the scene is transformed based on the central coordinates (Xi, Yi) to obtain the fused scene coordinates.

When acquiring the image data of pedestrian heads in the scene through at least two image acquisition devices, there is an area covered by both cameras in coordinate fusion process; or there may be some noise areas outside the scene area that will be detected by the camera. These areas are defined as ignored areas. Therefore, the ignored area can mainly include two parts. The first part is the overlapping area of the acquisition areas of two cameras. In this case, calculations are only based on one camera, and the image data of pedestrian heads acquired by the other camera will be ignored. The second part is the area that does not require pedestrian statistics based on on-site judgment, which can be artificially set. The head image data of the pedestrian appearing in the second part of the area is treated as noise data and not processed.

In step S120, based on the coordinates of at least one pedestrian, at least one pedestrian separately is counted within a corresponding grid of multiple grids obtained by dividing the scene.

Firstly, based on a predetermined fine granularity, the scene plane is divided into multiple grids. Parameters can be input through a program, which represent the number of segmented blocks in the X-axis and Y-axis directions. For example, if the X-axis direction is divided into 4 blocks and the Y-axis direction is divided into 5 blocks, the area will be divided into 20 grids. By setting parameters, different fine granularity for grid segmentation can be set.

Next, based on the second coordinates of the pedestrians in the coordinate system of the scene obtained in step S100 and multiple grids, at least one pedestrian is counted in the corresponding grid. In the process of dividing grids, all distance parameters are represented in the form of pixel values, that is, the actual coordinate position is transformed into coordinate data on a pixel value scale based on the installation position of the camera. For example, for pedestrian coordinates (x, y) of a distance parameter, they may be within (m, n) of the grid parameter. (m, n) can represent a grid block located at the intersection of the m-th row grid block along the X-axis direction and the n-th column grid block along the Y-axis direction, and (m, n) can be used as an index of that grid.

In the process of separately counting pedestrians in the corresponding grid, first, an index value is assigned to each grid of multiple grids in the coordinate system of the scene, such as (m, n) above. Then, by using length and width values of each grid of multiple grids, quotient values of the coordinates in length and width directions of each of at least one pedestrian separately along length and width directions of the multiple grids are taken. In this application, taking the length direction of the grid as the X-axis direction and the width direction of the grid as the Y-axis direction as an example for explanation, but this application is not limited to this. The quotient values include a first coordinate quotient value and a second coordinate quotient value, which correspond to the quotient values of the distance from the coordinate origin in the length and width directions, respectively. Finally, the first coordinate quotient value and the second coordinate quotient value are compared with the index value assigned to each grid mentioned above. If they match, the at least one pedestrian is placed in the corresponding grid based on this. That is to say, the first coordinate quotient values and the second coordinate quotient values of the coordinates of the at least one pedestrian located in the same grid respectively are the same, and each grid has different indices (i.e. pedestrians with different first coordinate quotient values and/or second coordinate quotient values are located in different grids).

In step S140, the number of the pedestrians in each grid of multiple grids is counted to draw a pedestrian thermodynamic diagram in the scene.

In this step, based on the preset parameters, pedestrian thermodynamic statistics is conducted at regular intervals. At a certain moment, the coordinate data of the pedestrians in the scene is obtained. Based on the size of the coordinate values, these coordinates are divided into different grids and the number of pedestrians within each grid are sum up. Finally, based on the index of the grid, the sum data over a period of time is stored in an array and output, thereby drawing a pedestrian thermodynamic diagram in the scene.

Specifically, counting the number of the pedestrians in each grid of multiple grids includes: counting the at least one pedestrian in each grid based on the image data acquired at each image data acquisition moment, to count the at least one pedestrian in each grid for the image data acquisition moment. That is, the pedestrians in each grid are counted, and the data images of pedestrians acquired each time are processed to count the number of pedestrians in each grid obtained for each acquisition, so as to calculate the number of pedestrians in each grid at each acquisition moment.

Furthermore, in some embodiments of the present application, the counting the number of the pedestrians in each grid of multiple grids further includes: marking and tracking the pedestrians in the scene, and then judging whether the coordinates of the tracked pedestrians obtained at two adjacent image data acquisition moments are within the same grid, not counting the pedestrians at later image data acquisition moment when they are within the same grid; counting the pedestrians undergoing changes at later image data acquisition moment when they are located in different grids. In this way, pedestrians, located in the same grid at two adjacent image data acquisition moments, cannot be counted repeatedly to ensure the accuracy of pedestrian count statistics.

In some embodiments of the present application, the counting the number of the at least one pedestrian in each grid of multiple grids to draw the pedestrian thermodynamic diagram in the scene includes: counting the at least one pedestrian in each grid separately for multiple image data acquisition moments; marking each grid differently based on difference in a sum of the number of the pedestrians in each grid at each image data acquisition moment; and determining different marks for each grid at multiple image data acquisition moments to obtain the time-varying pedestrian thermodynamic diagram in the scene. In a specific example, different display colors are drawn for the grids with difference in the sum of the numbers of the pedestrians counted, allowing observers to intuitively feel the density of pedestrians. FIG. 4 shows a pedestrian thermodynamic diagram according to an embodiment of the present application, where black dots represent the pedestrians, and the grids with different numbers of pedestrians have different colors.

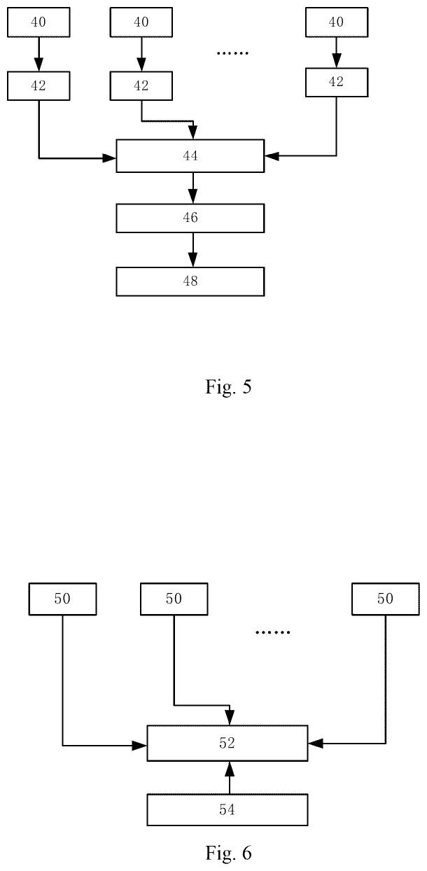

According to another aspect of this application, a system for generating pedestrian thermodynamic diagram is provided. FIG. 5 is a schematic diagram of a system for generating a pedestrian thermodynamic diagram according to an embodiment of the present application. The following is a detailed explanation of the present application with reference to FIG. 5.

As shown in FIG. 5, the system for a generating pedestrian thermodynamic diagram includes at least one image acquisition device 40, at least one detection module 42, a coordinate correction and fusion module 44, a thermodynamic diagram processing module 46, and a thermodynamic diagram generation module 48.

In some embodiments of the present application, at least one image acquisition device 40 may include at least one camera. The camera obtains video streams in a scene to obtain image data of pedestrians. In this application, the image data of the pedestrians in the scene can be respectively acquired at multiple image data acquisition moments every first predetermined time.

In some embodiments of the present application, at least one detection module 42 is connected one-to-one with at least one image acquisition device 40 to obtain coordinates of the pedestrians in the scene. The detection module 42 processes the video streams obtained by the camera to obtain head coordinates of pedestrians. The yolov5 algorithm, an efficient detection algorithm, can be used to establish a head detection model. The head detection model can be trained and tested using pre-stored head image data to obtain a better head detection model. Then head coordinates of the pedestrian in the scene are obtained by using the head detection model based on the head image data. In practical applications, algorithms can be migrated, compressed, and deployed according to the different platforms algorithms are deployed on, thereby improving the operational efficiency of the model while ensuring its accuracy.

In some embodiments of the present application, the coordinate correction and fusion module 44 is connected to at least one detection module 42 for correcting and fusing the head coordinates obtained through at least one detection module 42 based on the coordinate system of the scene. Coordinate errors are caused by perspective effect of the image acquisition device, resulting in errors in the obtained coordinates. Therefore, it is necessary to correct original coordinates based on the coordinate system of the image acquisition device. The coordinate correction and fusion module 44 can correct the original coordinates based on above formula (1) to obtain first coordinates.

In the case where at least one image acquisition device 40 includes multiple image acquisition devices 40, it is necessary to rotate first coordinates of the pedestrians obtained from the head image data acquired through at least two image acquisition devices. For example, through formula (2), the first coordinates of the pedestrians acquired through different image acquisition devices from their respective coordinate systems are transformed to second coordinates in the coordinate system of the scene, thereby fusing the first coordinates obtained through each image acquisition device 40 into the coordinate system of the scene.

In some embodiments of the present application, the thermodynamic diagram processing module 46 is connected to the coordinate correction and fusion module 44, which is used to count the pedestrians based on their coordinates within a corresponding grid of multiple grids obtained by dividing the scene.

The thermodynamic diagram processing module 46 can be configured to perform the following processing: dividing the scene into multiple grids based on predetermined fine granularity; and based on the coordinates of at least one pedestrian and multiple grids, counting at least one pedestrian within the corresponding grid. The thermodynamic diagram processing module 46 is further configured to: assigning an index value to each grid of multiple grids in the coordinate system of the scene; taking, by using length and width values of each grid of the multiple grids, quotient values of the coordinates in length and width directions of each of at least one pedestrian separately along length and width directions of the multiple grids, to obtain a first coordinate quotient value and a second coordinate quotient value corresponding to the coordinates of each pedestrian; and comparing the first coordinate quotient value and the second coordinate quotient value with the index value of each grid to count each pedestrian within the corresponding grid.

In some embodiments of the present application, the thermodynamic diagram generation module 48 is connected to the thermodynamic diagram processing module for counting the number of pedestrians in each grid of multiple grids, to draw a pedestrian thermodynamic diagram in the scene.

The thermodynamic diagram generation module 48 is configured to count the pedestrians within each grid based on the image data acquired at each image data acquisition moment, in order to count the pedestrians in each grid for each image data acquisition moment.

The thermodynamic diagram generation module 48 is further configured to: mark and track the pedestrians in the scene; judge whether the coordinates of the tracked pedestrians obtained at the adjacent two image data acquisition moments are located the same grid, not count the at least one pedestrian at later image data acquisition moment when the coordinates are located in the same grid; count the at least one pedestrian at later image data acquisition moment when the coordinates are located in different grids; and mark each grid differently based on difference in a sum of the number of the pedestrians in each grid. In specific examples, different display colors can be drawn for the grids with difference in the sum of the numbers of the pedestrians.

According to another aspect of this application, a system for generating pedestrian thermodynamic diagram is provided. FIG. 6 is a schematic diagram of a system for generating a pedestrian thermodynamic diagram according to an embodiment of the present application. As shown in FIG. 6, the system for generating a pedestrian thermodynamic diagram includes: at least one image acquisition device 50; a processor 52; and a memory 54.

At least one image acquisition device 50 is configured to acquire image data of pedestrians in a scene and send the image data to the processor and/or the memory 54. Moreover, the memory 54 stores an instruction that can be executed by the processor 52. The instruction, when executed by the processor 54, causes the processor 52 to perform the foregoing method for generating pedestrian thermodynamic diagram.

In some embodiments, at least one image acquisition device 50 includes one image acquisition device 50. A height of the image acquisition device is greater than heights of the pedestrians, and the image acquisition device is located at a center of the scene.

In some embodiments, at least one image acquisition device 50 includes at least two image acquisition devices 50. Heights of at least two image acquisition devices 50 are greater than heights of the pedestrians, and an image acquisition area of at least two image acquisition devices 50 covers the entire scene.

In this application, the image acquisition device is set at a position higher than the height of the pedestrians to acquire the head image data of the pedestrian, which can solve the problem of head occlusion and avoid missed detection of the head.

Furthermore, the implementation algorithm of the method for generating a pedestrian thermodynamic diagram in the application can be implemented on intelligent devices at the edge of the scene. Operational efficiency of the system can be greatly improved after conversion and compression.

It can be understood that the above embodiments of the present application are merely exemplary embodiments used for illustrating the principle of the present application, and the application is not limited thereto. For those skilled in the art, various modifications and improvements may be made without departing from the spirit and essence of the present application, and these variations and improvements are also deemed to be within the protection scope of the present application.

1. A method for generating a pedestrian thermodynamic diagram, comprising:
obtaining image data containing pedestrians and determining coordinates of at least one pedestrian in a scene;
counting, based on the coordinates of at least one pedestrian, the at least one pedestrian separately within a corresponding grid of multiple grids obtained by dividing the scene;
counting the number of the at least one pedestrian within each grid of multiple grids to draw a pedestrian thermodynamic diagram in the scene.

2. The method according to claim 1, wherein the counting, based on the coordinates of at least one pedestrian, the at least one pedestrian separately within the corresponding grid of multiple grids obtained by dividing the scene comprises:
dividing the scene into multiple grids based on a predetermined fine granularity;
counting the at least one pedestrian separately within the corresponding grid based on the coordinates of at least one pedestrian and the multiple grids.

3. The method according to claim 2, wherein the counting the at least one pedestrian separately within the corresponding grid based on the coordinates of at least one pedestrian and the multiple grids comprises:
assigning an index value to each grid of the multiple grids in a coordinate system of the scene:
taking, by using length and width values of each grid of the multiple grids, quotient values of the coordinates in length and width directions of each of at least one pedestrian separately along length and width directions of the multiple grids, to obtain a first coordinate quotient value and a second coordinate quotient value corresponding to the coordinates of each pedestrian; and
comparing the first coordinate quotient value and the second coordinate quotient value with the index value of each grid to count each pedestrian within the corresponding grid.

4. The method according to claim 1, wherein the obtaining image data containing pedestrians and determine coordinates of at least one pedestrian in the scene comprises:
acquiring the image data of the at least one pedestrian in the scene separately at multiple image data acquisition moments every first predetermined time; and
wherein the counting the number of the at least one pedestrian in each grid of the multiple grids comprises:
counting the at least one pedestrian in each grid based on the image data acquired at each image data acquisition moment, to count the at least one pedestrian in each grid for each image data acquisition moment.

5. The method according to claim 4, wherein the counting the number of the at least one pedestrian in each grid of multiple grids further comprises:
marking and tracking the at least one pedestrian in the scene; and
judging whether the coordinates of the tracked pedestrian obtained at two adjacent image data acquisition moments of the image data are located in a same grid;
not counting the at least one pedestrian at later image data acquisition moment when the coordinates are located in the same grid;
counting the at least one pedestrian at later image data acquisition moment when the coordinates are located in different grids.

6. The method according to claim 4, wherein the counting the number of the at least one pedestrian in each grid of the multiple grids to draw the pedestrian thermodynamic diagram in the scene comprises:
counting the at least one pedestrian in each grid separately for multiple image data acquisition moments;
marking each grid differently based on difference in a sum of the number of the at least one pedestrian in each grid at each image data acquisition moment; and
determining different marks for each grid at multiple image data acquisition moments to obtain the time-varying pedestrian thermodynamic diagram in the scene.

7. The method according to claim 6, wherein the marking each grid differently comprises: drawing different display colors for the grids depending on the difference in the sum of the number of the at least one pedestrian in each grid.

8. The method according to claim 4, wherein the obtaining image data containing pedestrians and determine coordinates of at least one pedestrian in the scene further comprises:
extracting first coordinates of the at least one pedestrian from the image data based on a coordinate system of an image acquisition device of the image data; and
transforming the first coordinates to a second coordinates based on a coordinate system of the scene, and using the second coordinates as coordinates of the at least one pedestrian in the scene.

9. The method according to claim 8, wherein the extracting first coordinates of the at least one pedestrian from the image data based on the coordinate system of the image acquisition device of the image data comprises:
obtaining original coordinates of the at least one pedestrian based on the coordinate system of the image acquisition device of the image data;
obtaining a correction value of the original coordinates through a following formula:
$$x = \frac{( \vert {x}_{2} - {x}_{1} \vert ) h}{H}$$
wherein, H represents a height of the image acquisition device of the image data, x2 represents center coordinates of the scene where the image acquisition device of the image data is located, x1 represents the original coordinates obtained by the image acquisition device, h represents a height of the at least one pedestrian, and x represents the correction value of the original coordinates; and
correcting the original coordinates by using the correction value of the original coordinates based on a quadrant of the coordinate system of the image acquisition device where the original coordinates are located, to obtain the first coordinates.

10. The method according to claim 9, wherein the height of the at least one pedestrian is a mode of heights of pedestrians.

11. The method according to claim 10, wherein the original coordinates, the first coordinates, and the second coordinates comprise head coordinates of the at least one pedestrian.

12. The method according to claim 11, wherein the acquiring the image data of the at least one pedestrian in the scene separately at multiple image data acquisition moments every first predetermined time comprises:
setting the image acquisition device at a position higher than the height of the at least one pedestrian to acquire head image data of the at least one pedestrian.

13. The method according to claim 12, wherein the setting the image acquisition device at the position higher than the height of the at least one pedestrian to acquire the head image data of the at least one pedestrian comprises:
acquiring the head image data of the at least one pedestrian through an image acquisition device located at a center of the scene.

14. The method according to claim 12, wherein the setting the image acquisition device at the position higher than the height of the at least one pedestrian to acquire the head image data of the at least one pedestrian comprises:
acquiring the head image data of the at least one pedestrian through multiple image acquisition devices having an acquisition area covering an entire scene.

15. The method according to claim 14, wherein, an acquisition overlapping area of at least two image acquisition devices is further included in the scene, and the acquiring the head image data of the at least one pedestrian through multiple image acquisition devices having the acquisition area covering the entire scene comprises:
selecting head image data of at least one pedestrian acquired by one of the at least two image acquisition devices corresponding to the acquisition overlapping area.

16. The method according to claim 15, wherein a noise area is further included in the scene, and the acquiring the head image data of the at least one pedestrian through multiple image acquisition devices having the acquisition area covering the entire scene comprises:
not acquiring head image data of at least one pedestrian in the noise area.

17. The method according to claim 8, wherein the transforming the first coordinates to the second coordinates based on the coordinate system of the scene comprises:
transforming, by rotating coordinates, the first coordinates based on the coordinate system of the image acquisition device of the image data to the second coordinates of the coordinate system of the scene.

18. A system for generating a pedestrian thermodynamic diagram, comprising:
at least one image acquisition device;
a processor; and
a memory,
wherein, the at least one image acquisition device is configured to acquire image data of at least one pedestrian in a scene and send the image data to the processor and/or the memory, and the memory stores an instruction that can be executed by the processor, the instruction, when executed by the processor, causes the processor to perform the method according to claim 1.

19. The system according to claim 18, wherein the at least one image acquisition device comprises one image acquisition device,
a height of the image acquisition device is greater than a height of the at least one pedestrian, and the image acquisition device is located at a center of the scene.

20. The system according to claim 18, wherein the at least one image acquisition device comprises at least two image acquisition devices,
heights of at least two image acquisition devices are greater than a height of the at least one pedestrian, and the at least two image acquisition devices have an image acquisition area covering an entire scene.
